(19) United States
(12) Patent Application Publication
(10) Pub. No.: US 2023/0167374 A1
(43) Pub. Date: Jun. 1, 2023

(54) HYDROGEN SULPHIDE AND MERCAPTANS SCAVENGING COMPOSITIONS

(71) Applicant: TOTALENERGIES ONETECH, Courbevoie (FR)

(72) Inventors: Hemant Surendra MONDKAR, PUNE (IN); Frédéric TORT, BRIGNAIS (FR)

(73) Assignee: TOTALENERGIES ONETECH, Courbevoie (FR)

(21) Appl. No.: 17/919,427

(22) PCT Filed: Apr. 21, 2021
(86) PCT No.: PCT/EP2021/060413

§ 371 Date: Oct. 17, 2022

(30) Foreign Application Priority Data
Apr. 22, 2020 (EP) 20170944.1

(51) Int. Cl. C10L 1/14

(52) U.S. Cl. CPC C10L 1/143; C10L 1/233; C10L 2290/545

(57) ABSTRACT

A composition for scavenging hydrogen sulphide and/or mercaptans in hydrocarbon streams includes a H2S scavenger selected from oxazolidine compounds, triazine and metal-based carboxylate compounds, and a synergistic additive allowing boosting the effect of the H2S scavenger compound.

### TECHNICAL FIELD

The present invention pertains to a novel hydrogen sulphide and mercaptans scavenging composition comprising a conventional H2S scavenger and a specific additive. The present invention also pertains to the use of the additive to improve the efficiency of the H2S scavenger for scavenging hydrogen sulphide and mercaptans in hydrocarbon streams. The present invention also relates to a method for scavenging hydrogen sulphide and/or mercaptans comprising contacting a hydrocarbon stream such as crude oil, fuel or natural gas with the scavenging composition of the invention.

### BACKGROUND OF THE INVENTION

Hydrogen sulphide is a colourless and fairly toxic, flammable and corrosive gas which also has a characteristic odour at a very low concentration. Hydrogen sulphide dissolves in hydrocarbon and water streams and is also found in the vapour phase above these streams and in natural gas. The hydrogen sulphide emissions can therefore be a nuisance to workers operating in the production, transport, storage, and processing of crude oil and in the storage of fuel. Hydrogen sulphide may also react with hydrocarbon components present in fuel. It would therefore be desirable for the workers’ comfort and safety to reduce or even eliminate the hydrogen sulphide emissions during the manipulation of said products.

Legislation has been in place for years, imposing strict regulations on hydrogen sulphide levels of hydrocarbon streams pipelines, and in storage and shipping containers. A variety of chemical scavengers are available to reduce both the concentration and corresponding hazard of hydrogen sulphide in produced gas, crude oil and refined products. Some of the most common methods for treating hydrogen sulphide include triazine, glyoxal, as well as metal-based scavengers. Glyoxal has been used extensively as hydrogen sulphide scavenger but suffers from a major drawback since aqueous glyoxal solutions are highly corrosive and cannot be used for a gas tower application. Triazines have recently become a more common chemical scavenger used for treating hydrogen sulphide from hydrocarbon streams.

Others hydrogen sulphide scavengers have been developed, and among them scavengers based on oxazolidine, like 3,3′-methylenebis(5-methyloxazolidine), known as MBO. A method for scavenging hydrogen sulphide from sour hydrocarbon substrates has been described in WO 98/02501. MBO presents the advantage to be less toxic and to create no scales in the conditions where triazine does.

However, this technology either MBO or triazine requires an important contact time in order to be efficient in sulphur removal and thus involves injection of higher doses.

Formulations of MBO with promoters, also named boosters, have been developed to enhance the efficiency of MBO. For example, WO 2017/102693 describes a composition comprising MBO and one or more additive selected among urea, urea derivatives, amino acids, guanidine, guanidine derivatives or 1,2-diols, said composition being used in the removal of sulphur compounds from process streams.

It would be useful to provide a composition enhancing the H₂S scavenging properties of conventional H2S scavengers.

### SUMMARY OF THE INVENTION

The present invention relates to a composition for scavenging hydrogen sulphide and mercaptans in hydrocarbon streams, said composition comprising at least one H2S scavenger compound and at least one additive,
the H2S scavenger compound being selected from oxazolidine compounds, triazine, and metal-based carboxylate, and
the additive being a copolymer comprising m units of formula (II) and p units of formula (III), wherein:

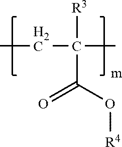

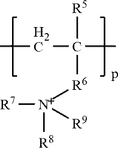

Wherein
R³ and R⁵ are, independently to each other, a hydrogen atom or a methyl group,
m is an integer ranging from 2 to 200,
p is an integer ranging from 2 to 100,
R⁴ represents independently to each other, a monovalent radical selected from linear, branched, cyclic, alkyl or alkenyl groups having from 1 to 36 carbon atoms and aryl groups having from 6 to 16 carbon atoms, said alkyl, alkenyl or aryl group may optionally be substituted by one or more heteroatoms, such as oxygen, sulfur, nitrogen atoms,
R⁶ represents independently to each other, a divalent radical selected from linear, branched, cyclic, alkylene or alkenylene groups having from 1 to 36 carbon atoms and arylene groups having from 6 to 16 carbon atoms, said alkylene, alkenylene or arylene group may optionally be substituted by one or more heteroatoms, such as oxygen, sulfur, nitrogen atoms,
R⁷, R⁸ and R⁹, are independently to each other, a monovalent radical selected from linear, branched, cyclic, alkyl or alkenyl groups having from 1 to 36 carbon atoms.

According to an embodiment, the copolymer has a number average molecular weight ranging from 500 to 40000 g/mol, preferably from 1000 to 30000 g/mol, more preferably from 1500 to 15000 g/mol.

According to an embodiment, wherein the copolymer comprises from 1 to 100 units of formula (II) and from 2 to 50 units of formula (III), preferably from 10 to 80 units of formula (II) and from 3 to 30 units of formula (III).

Preferably, in formula (II) and/or (III):
R⁴ represents, independently to each other, a monovalent radical selected from linear, branched, cyclic, alkyl or alkenyl groups having from 1 to 36 carbon atoms, preferably from linear or branched alkyl or alkenyl groups having from 2 to 24 carbon atoms, more preferably from linear or branched alkyl groups having from 3 to 18 carbon atoms; and/or
R⁶ represents, independently to each other, a divalent radical selected from linear, branched, cyclic, alkylene or alkenylene groups having from 1 to 36 carbon atoms, preferably from linear or branched alkyl groups having from 1 to 24 carbon atoms, preferably from 1 to 12 carbon atoms, and from arylene groups having from 6 to 12 carbon atoms; and/or
R⁷, R⁸ and R⁹, are independently to each other, a monovalent radical selected from linear, branched, cyclic, alkyl or alkenyl groups having from 1 to 36 carbon atoms, preferably from linear or branched alkyl or alkenyl groups having from 1 to 24 carbon atoms, more preferably from linear or branched alkyl groups having from 1 to 12 carbon atoms.

Preferably, in formula (II) and/or (III):
R³ and R⁵ represents independently to each other a hydrogen atom or a methyl group;
R⁴ represents, independently to each other, a monovalent radical selected from linear or branched alkyl groups having from 3 to 18 carbon atoms;
R⁶ represents a divalent group selected from —COO—R¹⁰—, OCOR¹⁰—, —Ph—CH₂—, wherein R¹⁰ is an alkylene group having from 1 to 12 carbon atoms and wherein Ph represents a phenyl group;
R⁷, R⁸ and R⁹, are independently to each other, a monovalent radical selected from linear or branched alkyl groups having from 1 to 12 carbon atoms.

According to an embodiment, the copolymer is a bloc copolymer, preferably a dibloc copolymer.

According to an embodiment, the composition of the invention comprises:
from 10 to 80%wt, preferably from 20 to 75%wt, more preferably from 25 to 60%wt of H2S scavenger compound, based on the total weight of the composition, and
from 0.5 to 30%wt, preferably from 1 to 20%wt, more preferably from 2 to 15%wt of active matter of copolymer additive(s), based on the total weight of the composition.

According to an embodiment of the invention, the weight ratio of H2S scavenger compound(s) to said additive(s) ranges from 1 to 50, preferably from 2 to 30, preferably from 4 to 20.

According to an embodiment, the composition further comprises at least one solvent, preferably in an amount ranging from 1 to 80%wt, preferably from 5 to 80%wt, more preferably from 10 to 70%wt, based on the total weight of the composition.

According to an embodiment of the invention, the composition comprises:
From 20 to 90%wt of H2S scavenger compound(s),
From 0.1 to 30%wt of active matter of said copolymer additive(s), and
From 10 to 70%wt of solvent(s),
based on the total weight of the composition.

Preferably, the H2S scavenger compound is an oxazolidine compound, preferably a bisoxazolidine compound, more preferably 3,3′-methylenebis(5-methyloxazolidine).

The present invention is also directed to the use of the additive defined in the present invention, for improving the efficiency of a H2S scavenger compound selected from oxazolidine compounds, triazine compounds, and metal-based carboxylate for scavenging hydrogen sulphide and/or mercaptans in hydrocarbon streams.

The present invention also relates to a hydrocarbon stream comprising hydrocarbons and a composition according to the invention.

According to an embodiment, the hydrocarbons are selected from crude oil, fuel oil, fuel, Light Petroleum Gas, natural gas, bitumen and petroleum residues.

The invention is also directed to a method for scavenging hydrogen sulphide and/or mercaptans in hydrocarbon streams, comprising contacting the hydrocarbon stream with the composition according to the invention.

The composition of the present invention enables to reduce the treat rate, i.e. reduce the amount of H2S scavenger necessary to scavenge a given amount of hydrogen sulphide from the sulphur containing stream.

The scavenging composition of the present invention also enables to improve the scavenging properties. The improvement can be seen when the remaining amount of sulphur compounds in the hydrocarbon stream is reduced and/or when the duration of the scavenging of sulphur compounds is increased thanks to the introduction of the scavenging composition according to the invention into the hydrocarbon stream.

The scavenging composition of the present invention allows a fast and long scavenging.

### BRIEF DESCRIPTION OF THE FIGURES

FIG. 1 represents the amount of hydrogen sulphide in ppm in function of the time during the test for different scavenging compositions.

FIG. 2 represents the amount of hydrogen sulphide in ppm in function of the time during the test for different scavenging compositions.

### DETAILED DESCRIPTION OF THE INVENTION

The present invention concerns a hydrogen sulphide and mercaptans scavenging composition comprising at least one H2S scavenger compound and at least one additive.

### The H2S Scavenger Compound

According to the present invention, the H2S scavenger is selected from oxazolidine compounds, triazine compounds and metal-based carboxylate compounds, and mixtures thereof.

According to a particular embodiment, the oxazolidine compound is selected from bisoxazolidines, i.e. compounds comprising two oxazolidine cycles.

According to a particular embodiment, the oxazolidine compound replies to formula (I):

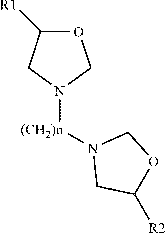

wherein
n is an integer ranging from 1 to 6, preferably from 1 to 2;
R1 and R2, identical or different, are selected from a hydrogen atom and a linear, branched or cyclic alkyl or alkenyl groups having from 1 to 6 carbon atoms, preferably from 1 to 2 carbon atoms.

Preferably, the oxazolidine compound is 3,3′-methylenebis(5-methyloxazolidine).

According to an embodiment, the triazine is selected from monoethanolamine triazine (MEA-triazine); monomethylamine triazine (MMA-triazine); 1,3,5(tris-methoxybutyl)hexahydrotriazine; 1,3,5-(tris-ethyl)hexahydrotriazine ; 1,3,5(tris-propyl)hexahydrotriazine; 1,3,5-Tris(2-hydroxyethyl)hexahydro-1,3,5-triazine; 1,3,5-Triethylhexahydro-1,3,5-triazine; 1,3,5-Tris[3-(dimethylamino)propyl]hexahydro-1,3,5-triazine; 1,3,5-Trimethylhexahydro-1,3,5-triazine.

According to a particular embodiment, the metal-based carboxylate is selected from zinc carboxylate and from iron carboxylate, having preferably from 4 to 24 carbon atoms.

According to an embodiment, the metal-based carboxylate is selected from zinc carboxylate having from 4 to 24 carbon atoms. The metal-based carboxylate can for example be zinc octoate or zinc naphthenate. It may be noted that the zinc octoate can be a zinc oxo octoate.

As an example, document US 5,000,835 and US 8,246,813 disclose metal-based carboxylates as hydrogen sulphide scavenger.

According to an embodiment of the invention, the H2S scavenger compound is selected from bisoxazolidines, monoethanolamine triazine (MEA-triazine); monomethylamine triazine (MMA-triazine); 1,3,5(tris-methoxybutyl)hexahydrotriazine; 1,3,5-(tris-ethyl)hexahydrotriazine ; 1,3,5(tris-propyl)hexahydrotriazine, 1,3,5-Tris(2-hydroxyethyl)hexahydro-1,3,5-triazine; 1,3,5-Triethylhexahydro-1,3,5-triazine; 1,3,5-Tris[3-(dimethylamino)propyl]hexahydro-1,3,5-triazine; 1,3,5-Trimethylhexahydro-1,3,5-triazine and zinc carboxylate.

According to an embodiment of the invention, the H2S scavenger compound is selected from 3,3′-methylenebis(5-methyloxazolidine), monoethanolamine triazine (MEA-triazine); monomethylamine triazine (MMA-triazine); 1,3,5(tris-methoxybutyl)hexahydrotriazine; 1,3,5-(tris-ethyl)hexahydrotriazine ; 1,3,5(tris-propyl)hexahydrotriazine, and zinc octanoate.

According to a particular embodiment, the H2S scavenger compound is selected from oxazolidines and triazine, preferably from bisoxazolidines, monoethanolamine triazine (MEA-triazine); monomethylamine triazine (MMA-triazine); 1,3,5(tris-methoxybutyl)hexahydrotriazine; 1,3,5-(tris-ethyl)hexahydrotriazine ; 1,3,5(tris-propyl)hexahydrotriazine; 1,3,5-Tris(2-hydroxyethyl)hexahydro-1,3,5-triazine; 1,3,5-Triethylhexahydro-1,3,5-triazine; 1,3,5-Tris[3-(dimethylamino)propyl]hexahydro-1,3,5-triazine; 1,3,5-Trimethylhexahydro-1,3,5-triazine.

According to an embodiment of the invention, the H2S scavenger compound is selected from 3,3′-methylenebis(5-methyloxazolidine), monoethanolamine triazine (MEA-triazine); monomethylamine triazine (MMA-triazine); 1,3,5(tris-methoxybutyl)hexahydrotriazine; 1,3,5-(tris-ethyl)hexahydrotriazine ; 1,3,5(tris-propyl)hexahydrotriazine.

According to an embodiment of the invention, the H2S scavenger compound is selected from 3,3′-methylenebis(5-methyloxazolidine).

According to a preferred embodiment, the H2S scavenger compound represents from 10 to 99%wt of the total weight of the scavenging composition, preferably from 30 to 98%wt of the total weight of the scavenging composition, even more preferably from 40 to 95%wt of the total weight of the scavenging composition.

According to the present invention, the additive is a copolymer comprising m units of formula (II) and p units of formula (III), wherein:

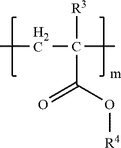

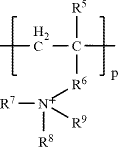

Wherein
R³ and R⁵ are, independently to each other, a hydrogen atom or a methyl group,
m is an integer ranging from 2 to 200,
p is an integer ranging from 2 to 100,
R⁴ represents independently to each other, a monovalent radical selected from linear, branched, cyclic, alkyl or alkenyl groups having from 1 to 36 carbon atoms and aryl groups having from 6 to 16 carbon atoms, said alkyl, alkenyl or aryl group may optionally be substituted by one or more heteroatoms, such as oxygen, sulfur, nitrogen atoms,
R⁶ represents independently to each other, a divalent radical selected from linear, branched, cyclic, alkylene or alkenylene groups having from 1 to 36 carbon atoms and arylene groups having from 6 to 16 carbon atoms, said alkylene, alkenylene or arylene group may optionally be substituted by one or more heteroatoms, such as oxygen, sulfur, nitrogen atoms,
R⁷, R⁸ and R⁹, are independently to each other, a monovalent radical selected from linear, branched, cyclic, alkyl or alkenyl groups having from 1 to 36 carbon atoms.

According to an embodiment, the additive has a number average molecular weight ranging from 500 to 40000 g/mol, preferably from 1000 to 30000 g/mol, more preferably from 1500 to 15000 g/mol. The number average molecular weight can be measured by size exclusion chromatography using for example a polymethyl methacrylate sample.

According to an embodiment, the polymer comprises from 1 to 100 units of formula (II) and from 2 to 50 units of formula (III), preferably from 10 to 80 units of formula (II) and from 3 to 30 units of formula (III).

According to an embodiment, units of formula (II) and/or formula (III) have one or more of the following features:
R⁴ represents, independently to each other, a monovalent radical selected from linear, branched, cyclic, alkyl or alkenyl groups having from 1 to 36 carbon atoms, preferably from linear or branched alkyl or alkenyl groups having from 2 to 24 carbon atoms, more preferably from linear or branched alkyl groups having from 3 to 18 carbon atoms;
R⁶ represents, independently to each other, a divalent radical selected from linear, branched, cyclic, alkylene or alkenylene groups having from 1 to 36 carbon atoms, preferably from linear or branched alkyl groups having from 1 to 24 carbon atoms, preferably from 1 to 12 carbon atoms, and from arylene groups having from 6 to 12 carbon atoms;
R⁷, R⁸ and R⁹, are independently to each other, a monovalent radical selected from linear, branched, cyclic, alkyl or alkenyl groups having from 1 to 36 carbon atoms, preferably from linear or branched alkyl or alkenyl groups having from 1 to 24 carbon atoms, more preferably from linear or branched alkyl groups having from 1 to 12 carbon atoms.

According to an embodiment, in formula (III), R⁶ represents a divalent group selected from —COO—R¹⁰—, OCOR¹⁰—, —Ph—CH₂—, wherein R¹⁰ is an alkylene group having from 1 to 12 carbon atoms and wherein Ph represents a phenyl group.

According to an embodiment, when R⁶ is an arylene group, preferably, R⁵ is hydrogen.

According to an embodiment, the copolymer is a bloc copolymer comprising, preferably, consisting of, blocs with repetition units of formula (II) and blocs with repetition units of formula (III).

According to a preferred embodiment, all the units of formula (II) are identical and/or all the units of formula (III) are identical.

According to an embodiment, the copolymer consists in units of formula (II) and units of formula (III), being understood that the polymer necessarily has end groups. In other words, according to this specific embodiment, the polymer does not contain repetition units that do not reply to formula (II) or formula (III).

The copolymer can be obtained by the following process:
a) Copolymerisation of monomers of formula (IIa) and of monomers of formula (IIIa), preferably with a control polymerisation in order to obtain a bloc copolymer,
b) Quaternization of the copolymer obtained with a quaternizing agent, Wherein:

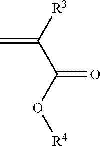

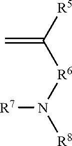

wherein R³, R⁴, R⁵, R⁶, R⁷ and R⁸ have the same definition as in formula (II) and (III) detailed above, including the particular embodiments.

According to an embodiment, monomers of formula (IIIa) are selected from monomers of formula (IV) and of formula (V):

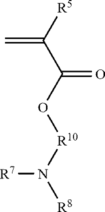

And

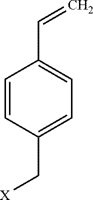

Wherein
R⁵, R⁷, R⁸ have the same definition as in formula (III) detailed above,
R¹⁰ is an alkylene group having from 1 to 12 carbon atoms,
X is an halogen atom, preferable X is chlorine atom.

The copolymerization may be performed according to well-known polymerization methods. Preferably, the copolymerization is a bloc copolymerization, preferably a bloc and controlled copolymerization, optionally followed by one or more post-functionalization, in particular one post-quaternization.

Byoungjae Kim et al, Reactive and Functional Polymers 120 (2017) 147-152, describe routes for copolymerization followed by a quaternization.

The copolymers of the invention can be prepared according to a process described in documents WO2017/046526 and WO2019/069010, in particular in example 1 (from page 46 to page 50) of WO2019/069010 or in examples 1 and 2 of WO2017/046526.

The end-group of the copolymer of the invention can be selected from sulphurous, phosphorous or hydrogen end-groups. As well known for the skilled person, the copolymerisation reaction may involve the use of quench groups or terminator groups in order to stop the copolymerisation.

The quaternization can be carried out by well-known method for the skilled person, in particular with a quaternizing agent selected from the group constituted by the dialkyl sulphates, the carboxylic acid esters; the alkyl halides, the benzyl halides, the hydrocarbon carbonates, and the hydrocarbon epoxides optionally mixed with an acid, alone or in a mixture.

Alternatively, if the pending groups of the copolymer (before quaternization) are selected from the group constituted by the dialkyl sulphates, the carboxylic acid esters; the alkyl halides, the benzyl halides, the hydrocarbon carbonates, and the hydrocarbon epoxides optionally mixed with an acid, alone or in a mixture, then the quaternization can be performed with a quaternizing agent selected from tertiary amines.

In particular, the quaternization can also be carried out using a ternary amine compound, such as a dimethylethyl amine. This embodiment is particularly useful in order to quaternize a unit of the copolymer having a benzyl halide group, such as a benzyl chloride group derived from 4-vinylbenzyl chloride monomer.

For fuel applications, it is often desirable to reduce the content of halogen, sulphur and the phosphorus-containing compounds. Thus, if a quaternizing agent containing such an element is used, it may be advantageous to carry out a subsequent reaction for exchange of the counter-ion. For example, a quaternary ammonium salt formed by reaction with an alkyl halide may then be reacted with sodium hydroxide and the sodium halide salt may be removed by filtration.

The quaternizing agent may comprise halides such as chloride, iodide or bromide; hydroxides; sulphonates; bisulphites; alkyl sulphates such as dimethyl sulphate; sulphones; phosphates; C₁-C₁₂ alkyl phosphates; C₁-C₁₂ dialkyl phosphates; borates; C₁-C₁₂ alkyl borates; nitrites; nitrates; carbonates; bicarbonates; alkanoates; C₁-C₁₂ O,O-dialkyldithiophosphates, alone or in a mixture.

According to a particular embodiment, the quaternizing agent may be derived from dialkyl sulphates such as dimethyl sulphate, from N-oxides, from sulphones such as propane- and butane-sulphone, from alkyl halides, from acyl or from aralkyl such as methyl and ethyl chloride, benzyl bromide, iodide or chloride, and the alkyl carbonates. If the acyl halide is benzyl chloride, the aromatic ring is optionally substituted with one or more alkyl or alkenyl groups. The alkyl group of the alkyl carbonates may contain from 1 to 50, from 1 to 20, from 1 to 10 or 1 to 5 carbon atoms per group.

According to a particular embodiment, the alkyl carbonates contain two alkyl groups, which may be identical or different. As an example of alkyl carbonates, dimethyl or diethyl carbonate may be mentioned.

According to an embodiment, the additive polymer represents from 0.5 to 50%wt, preferably from 1 to 45%wt, even more preferably from 1.5 to 40%wt, more preferably from 2 to 30%wt, of the total weight of the scavenging composition.

According to an embodiment, the H₂S and mercaptans scavenging composition comprises from 19 to 99.5%wt, preferably from 40 to 99%wt, more preferably from 55 to 79%, more preferably from 60 to 95%wt, even more preferably from 70 to 90%wt of H2S scavenger compound(s) and from 0.5 to 50%wt, preferably from 1 to 45%wt, even more preferably from 1.5 to 40%wt, more preferably from 2 to 30%wt of synergistic additive(s), based on the total weight of the H₂S and mercaptans scavenging composition.

Preferably, the weight ratio of H2S scavenger compound(s) to polymer additive(s) ranges from 1 to 100, preferably from 1 to 50, more preferably from 2 to 30, even more preferably from 4 to 20.

According to an embodiment, the H₂S and mercaptans scavenging composition further comprises at least one solvent.

Preferably, the solvent is selected from poly alkyl ethers, aliphatic or aromatic solvents, such as N-methylpyrrolidone, butyl carbitol, xylene, toluene, and benzene. It has been observed that the scavenging efficiency of the compositions of the invention is not dependent on the solvent. However, depending on the final use of the scavenging composition, a solvent having a dual solubility, i.e. a water solubility and a solubility in hydrocarbons, can be preferred. Butyl carbitol is a suitable solvent since it has this dual solubility.

Depending on the solubility of the copolymer and the scavenger, a co-solvent can be used. Among co-solvent, mention may be made of alcohols.

According to this embodiment, the solvent represents from 1 to 85%wt of the composition, preferably from 5 to 80%wt, more preferably from 10 to 70%wt, even more preferably from 20 to 60%wt of the composition.

According to a particular embodiment of the invention, the scavenging composition comprises:
From 10 to 90%wt, preferably from 20 to 80%wt, more preferably from 30 to 70%wt of H2S scavenger compound(s),
From 0.1 to 30%wt, preferably from 0.5 to 20%wt, more preferably from 1 to 15%wt, even more preferably from 2 to 10%wt of the copolymer additive(s) defined in the invention, and
From 5 to 80%wt, preferably from 10 to 70%wt, more preferably from 20 to 60%wt of solvent(s),
based on the total weight of the composition.

According to a particular embodiment of the invention, the scavenging composition comprises:
From 10 to 90%wt, preferably from 20 to 80%wt, more preferably from 30 to 70%wt of H2S scavenger compound(s) selected from oxazolidines and triazine,
From 0.1 to 30%wt, preferably from 0.5 to 20%wt, more preferably from 1 to 15%wt, even more preferably from 2 to 10%wt of the copolymer additive(s) defined in the invention, and
From 5 to 80%wt, preferably from 10 to 70%wt, more preferably from 20 to 60%wt of solvent(s),
based on the total weight of the composition.

According to a particular embodiment of the invention, the scavenging composition comprises:
From 10 to 90%wt, preferably from 20 to 80%wt, more preferably from 30 to 70%wt of H2S scavenger compound(s) selected from bisoxazolidines, monoethanolamine triazine (MEA-triazine); monomethylamine triazine (MMA-triazine); 1,3,5(tris-methoxybutyl)hexahydrotriazine; 1,3,5-(tris-ethyl)hexahydrotriazine ; 1,3,5(tris-propyl)hexahydrotriazine; 1,3,5-Tris(2-hydroxyethyl)hexahydro-1,3,5-triazine; 1,3,5-Triethylhexahydro-1,3,5-triazine; 1,3,5-Tris[3-(dimethylamino)propyl]hexahydro-1,3,5-triazine; 1,3,5-Trimethylhexahydro-1,3,5-triazine,
From 0.1 to 30%wt, preferably from 0.5 to 20%wt, more preferably from 1 to 15%wt, even more preferably from 2 to 10%wt of the copolymer additive(s) defined in the invention, and
From 5 to 80%wt, preferably from 10 to 70%wt, more preferably from 20 to 60%wt of solvent(s),
based on the total weight of the composition.

According to an embodiment of the invention, the composition comprises:
From 10 to 90%wt, preferably from 20 to 80%wt, more preferably from 30 to 70%wt of oxazolidine compound(s),
From 0.1 to 30%wt, preferably from 0.5 to 20%wt, more preferably from 1 to 15%wt, even more preferably from 2 to 10%wt of the copolymer additive(s) defined in the invention having preferably a number average molecular weight ranging from 500 to 40000 g/mol, preferably from 1000 to 30000 g/mol, more preferably from 1500 to 15000 g/mol, and
From 5 to 80%wt, preferably from 10 to 70%wt, more preferably from 20 to 60%wt of solvent(s),
based on the total weight of the composition.

According to an embodiment of the invention, the composition comprises:
From 10 to 90%wt, preferably from 20 to 80%wt, more preferably from 30 to 70%wt of H2S scavenger compound(s) selected from oxazolidines and triazine,
From 0.1 to 30%wt, preferably from 0.5 to 20%wt, more preferably from 1 to 15%wt, even more preferably from 2 to 10%wt of copolymer additive(s), and
From 5 to 80%wt, preferably from 10 to 70%wt, more preferably from 20 to 60%wt of solvent(s),
based on the total weight of the composition,

wherein the copolymer additive(s) are selected from copolymer comprising, preferably consisting in, m repetition units of formula (II) and p repetition units of formula (III) wherein:
m ranges from 1 to 100;
p ranges from 2 to 50;
R³ and R5 represents independently to each other a hydrogen atom or a methyl group;
R⁴ represents, independently to each other, a monovalent radical selected from linear, branched, cyclic, alkyl or alkenyl groups having from 1 to 36 carbon atoms, preferably from linear or branched alkyl or alkenyl groups having from 2 to 24 carbon atoms, more preferably from linear or branched alkyl groups having from 3 to 18 carbon atoms;
R⁶ represents a divalent group selected from —COO—R¹⁰—, OCOR¹⁰—, —Ph—CH₂—, wherein R¹⁰ is an alkylene group having from 1 to 12 carbon atoms and wherein Ph represents a phenyl group;
R⁷, R⁸ and R⁹, are independently to each other, a monovalent radical selected from linear, branched, cyclic, alkyl or alkenyl groups having from 1 to 36 carbon atoms, preferably from linear or branched alkyl or alkenyl groups having from 1 to 24 carbon atoms, more preferably from linear or branched alkyl groups having from 1 to 12 carbon atoms.

According to an embodiment of the invention, the composition comprises:
From 10 to 90%wt, preferably from 20 to 80%wt, more preferably from 30 to 70%wt of oxazolidine compound(s),
From 0.1 to 30%wt, preferably from 0.5 to 20%wt, more preferably from 1 to 15%wt, even more preferably from 2 to 10%wt of copolymer additive(s), and
From 5 to 80%wt, preferably from 10 to 70%wt, more preferably from 20 to 60%wt of solvent(s),
based on the total weight of the composition,

wherein the copolymer additive(s) are selected from copolymer comprising, preferably consisting in, m repetition units of formula (II) and p repetition units of formula (III) wherein:
m ranges from 1 to 100;
p ranges from 2 to 50;
R³ and R5 represents independently to each other a hydrogen atom or a methyl group;
R⁴ represents, independently to each other, a monovalent radical selected from linear, branched, cyclic, alkyl or alkenyl groups having from 1 to 36 carbon atoms, preferably from linear or branched alkyl or alkenyl groups having from 2 to 24 carbon atoms, more preferably from linear or branched alkyl groups having from 3 to 18 carbon atoms;
R⁶ represents a divalent group selected from —COO—R¹⁰—, OCOR¹⁰—, —Ph—CH₂—, wherein R¹⁰ is an alkylene group having from 1 to 12 carbon atoms and wherein Ph represents a phenyl group;
R⁷, R⁸ and R⁹, are independently to each other, a monovalent radical selected from linear, branched, cyclic, alkyl or alkenyl groups having from 1 to 36 carbon atoms, preferably from linear or branched alkyl or alkenyl groups having from 1 to 24 carbon atoms, more preferably from linear or branched alkyl groups having from 1 to 12 carbon atoms.

According to an embodiment of the invention, the composition comprises:
From 20 to 90%wt, preferably from 30 to 80%wt of oxazolidine compound(s),
From 0.1 to 30%wt, preferably from 1 to 15%wt, even more preferably from 2 to 10%wt of copolymer additive(s), and
From 10 to 70%wt, more preferably from 15 to 60%wt of solvent(s),
based on the total weight of the composition,

wherein the copolymer additive(s) are selected from copolymer comprising, preferably consisting in, m repetition units of formula (II) and p repetition units of formula (III) wherein:
m ranges from 10 to 80;
p ranges from 3 to 30;
R³ and R⁵ represents independently to each other a hydrogen atom or a methyl group;
R⁴ represents, independently to each other, a monovalent radical selected from linear or branched alkyl groups having from 3 to 18 carbon atoms;
R⁶ represents a divalent group selected from —COO—R¹⁰—, OCOR¹⁰—, —Ph—CH₂—, wherein R¹⁰ is an alkylene group having from 1 to 12 carbon atoms and wherein Ph represents a phenyl group;
R⁷, R⁸ and R⁹, are independently to each other, a monovalent radical selected from linear or branched alkyl groups having from 1 to 12 carbon atoms.

The present invention also concerns the use of the additive defined above for improving the efficiency of the H2S scavenger compound defined above for scavenging hydrogen sulphide (H2S) and/or mercaptans in hydrocarbon streams.

The “additive” used in the invention is also named the “synergistic additive”, since when used in combination with a H2S scavenger compound, it can boost the effect of the H2S scavenger compound for scavenging H2S and/or mercaptans in hydrocarbon streams.

By hydrocarbon stream is meant either a single-phase hydrocarbon stream or a multiphase system comprising oil/water or oil/water/gas or gas/water.

Preferably, the weight ratio H2S scavenger compound(s) to synergistic additive(s) ranges from 1 to 50, preferably from 2 to 30, preferably from 4 to 20.

Hydrocarbon streams contain H₂S and/or mercaptans, in an amount for example ranging from 1 to 10 000 ppm. Mercaptans that can be removed from hydrocarbon streams within the framework of the present invention may be C₁-C₆ mercaptans, such as C₁-C₄ mercaptans.

The present invention also concerns the use of the composition defined above as a H₂S and/or mercaptans scavenger in hydrocarbon streams, said hydrocarbon streams being preferably selected from crude oil, fuel, natural gas, Light Petroleum Gas, bitumen and petroleum residue. The composition of the invention is contacted with hydrocarbon streams such as crude oil, fuel, natural gas, bitumen or petroleum residue in order to reduce the amount of hydrogen sulphide (H₂S) and mercaptans. Hydrocarbon streams may be selected from crude oils and fuels which typically comprise more than 70%wt of paraffins, preferably more than 90%wt of paraffins and even more preferably more than 95%wt of paraffins, based on the total weight of the crude oils and fuels. Hence, hydrocarbon streams may be selected from crude oils and fuels which typically comprise less than 30%wt of aromatics, preferably less than 10%wt of aromatics and even more preferably less than 5%wt of aromatics, based on the total weight of the crude oils and fuels.

Hydrocarbon streams contain H₂S and/or mercaptans, in an amount for example ranging from 1 to 10 000 ppm. Mercaptans that can be removed from hydrocarbon streams within the framework of the present invention may be C₁-C₆ mercaptans, such as C₁-C₄ mercaptans.

According to an embodiment of the present invention, the weight ratio H₂S:scavenging composition ranges from 1:2 to 1:0.05, preferably from 1:1 to 1:0.1, more preferably from 1:0.9 to 1:0.2, even more preferably from 1:0.7 to 1:0.3 and advantageously from 1:0.8 to 1:0.4. In this ratio, H₂S represents the amount of hydrogen sulphide in the hydrocarbon streams, before contacting with the scavenging composition of the invention.

The present invention also concerns hydrocarbon streams comprising hydrocarbons and the scavenging composition of the invention. The hydrocarbon streams considered in the present invention may be either single-phase hydrocarbon streams or multiphase systems comprising oil/water or oil/water/gas or gas/water.

Hydrocarbons may be selected from crude oil, fuel oil, fuel, Light Petroleum Gas, natural gas, bitumen and petroleum residue. Hydrocarbon streams may be selected from crude oils and fuels which typically comprise more than 70%wt of paraffins, preferably more than 90%wt of paraffins and even more preferably more than 95%wt of paraffins, based on the total weight of the crude oils and fuels. Hence, hydrocarbon streams may be selected from crude oils and fuels which typically comprise less than 30%wt of aromatics, preferably less than 10%wt of aromatics and even more preferably less than 5%wt of aromatics, based on the total weight of the crude oils and fuels.

Hydrocarbon streams contain H₂S and/or mercaptans, in an amount for example ranging from 1 to 10 000 ppm. Mercaptans that can be removed from hydrocarbon streams within the framework of the present invention may be C₁-C₆ mercaptans, such as C₁-C₄ mercaptans.

The composition of the invention may represent from 0.0005 to 5 % by weight of the total weight of the hydrocarbon streams.

According to an embodiment of the present invention, the weight ratio H₂S:scavenging composition ranges from 1:2 to 1:0.05, preferably from 1:1 to 1:0.1, more preferably from 1:0.9 to 1:0.2, even more preferably from 1:0.7 to 1:0.3 and advantageously from 1:0.8 to 1:0.4. In this ratio, H₂S represents the amount of hydrogen sulphide of the hydrocarbon streams, before contacting with the scavenging composition of the invention.

### EXAMPLES

The invention is now described with the help of the following examples, which are not intended to limit the scope of the present invention, but are incorporated to illustrate advantages of the present invention and best mode to perform it.

### EXAMPLE 1: Description of the Scavenging Compositions Prepared and Tested

Different scavenging compositions have been prepared and tested. The products that have been used are:
MBO (3,3′-methylenebis(5-methyloxazolidine)),
MEAT comprising 80%wt MEA-triazine and 20%wt of water,
Xylene as a solvent,
P1 = dibloc copolymer obtained by bloc copolymerization of dodecyl acrylate (DDA) and 4-vinylbenzyl chloride (VBC) followed by quaternization with dimethylethylamine. P1 comprises 28 units derived from DDA and 5 units derived from VBC and has a Mn of 8000 g/mol. The polymer solution of P1 comprises about 42%wt of active matter.
P2 = dibloc copolymer obtained by bloc copolymerization of butyl acrylate (BuA) and 2-(dimethylamino)ethyl acrylate (DMAEA) followed by quaternization with epoxybutane. P2 comprises 41 units derived from BuA and 5 units derived from DMAEA and has a Mn of 5800 g/mol. The polymer solution of P2 comprises about 40%wt of active matter.
P3 = dibloc copolymer obtained by bloc copolymerization of butyl acrylate (BuA) and 4-vinylbenzyl chloride (VBC) followed by quaternization with dimethylaminoethanol. P3 comprises 56 units derived from BuA and 7 units derived from VBC and has a Mn of 8900 g/mol. The polymer solution of P3 comprises about 53%wt of active matter.

Polymers P1, P2 and P3 are prepared by a process similar to the process described in example 1 of WO2019/069010 and in examples 1 and 2 of WO2017/046526.

Scavenging compositions are prepared by mixing ingredient at ambient temperature.

Table 1 below summarizes the scavenging compositions that were tested.

TABLE 1

Compositions

| H₂S scavenging composition | MEAT (wt%) | MBO (wt%) | Synergistic additive | | Solvent (wt%) xylene | Butyl carbitol (wt%) | Water (wt%) |
|---|---|---|---|---|---|---|---|
| | | | Polymer | (%wt of polymer solution) | | | |
| C1 | | 50 | | 0 | 50 | 0 | 0 |
| C2 | | 0 | P1 | 50 | 50 | 0 | 0 |
| C3 | | 0 | P2 | 50 | 50 | 0 | 0 |
| C4 | | 0 | P3 | 50 | 50 | 0 | 0 |
| C5 | 62.5 | 0 | | 0 | 0 | 0 | 37.5 |
| I1 | | 50 | P1 | 5 | 45 | 0 | 0 |
| I2 | | 50 | P2 | 5 | 45 | 0 | 0 |
| I3 | | 50 | P3 | 5 | 45 | 0 | 0 |
| I4 | 62.5 | 0 | P1 | 5 | 0 | 32.5 | 0 |
| I5 | 62.5 | 0 | P2 | 5 | 0 | 32.5 | 0 |
| I6 | 62.5 | 0 | P3 | 5 | 0 | 32.5 | 0 |

It is noted that an amount of 62.5%wt MEAT leads to a composition comprising 50%wt of active MEA-triazine since MEAT comprises 80%wt of active product.

The H₂S scavengers MBO and MEA-triazine are each compared on the basis of 50%wt of active product.

### Example 2: Protocol of Experiment for the Measurement of H₂S Scavenging Ability of the Scavenging Compositions Under Modified ASTM D-5705 Conditions

ASTM D-5705 is recommended for measurement of Hydrogen sulfide in a vapor phase above the residual fuel oils. Performance evaluation of the various products and formulations developed as Hydrogen Sulfide Scavengers were evaluated using modified ASTM D-5705 test method.

In a typical experiment, 1 liter tin metal bottles with inner and outer caps were used to prepare and hold the test media. A dearomatized hydrocarbon solvent having an initial boiling point higher than 120° C., a final boiling point higher than 250° C. and a flash point above 100° C. with aromatic content less than 0.05%wt has been used for the tests.

In a representative experimental set, a defined amount of H₂S saturated hydrocarbon solvent, typically between 2000 and 7000 ppm by weight of H₂S, was injected in 1 liter tin metal bottle pre-filled with 500 ml of dearomatized hydrocarbon solvent through the silicon septa fixed at the opening of the bottle using micro-syringe. The metal bottle was then kept on a reciprocating shaking machine for 5 min to allow proper mixing of the H₂S gas. The tin metal bottle was then kept in a water bath at 60° C. for two hours. After two hours, the tin metal bottle was taken out and cooled down to room temperature under running tap water and kept aside. An H₂S detecting tube (Dräger tube, with typical detection limit ranging from 100 to 70 000 ppm by weight) was inserted in a rubber cork through a hole having the same diameter as the detecting tube. The sealed ends of the H₂S detecting tube were opened with an appropriate opener, one end of the tube being attached to Dräger pump. The silicon septa mounted at the opening of the tin metal bottles was removed and very quickly the rubber cork with H₂S detector tube was inserted inside the opening of the tin metal bottle. The H₂S gas in the vapor phase of the tin metal bottle was then pulled through the H₂S measuring tube using Dräger pump attached at the other end of the tube. The detector tube was removed after complete decompression of the pump. H₂S concentration was read from the tubes calibration scale (typically color change from colorless to brown). This reading was noted as a reference Blank reading of H₂S amount.

Further, same amount of H₂S containing dearomatized hydrocarbon solvent was injected into other tin metal bottles, which are pre-filled with 500 mL of the dearomatized hydrocarbon, and H₂S scavengers at different ratios of scavenger against H₂S, based on the Blank reading. Typical H₂S:scavenger ratios employed were 1:1, 1:0.9, 1:0.8, 1:0.7, 1:0.6, 1:0.5, 1:0.4, 1:0.3, 1:0.2 and 1:0.1. All the metal bottles were kept in a water bath for two hours at 60° C. Similar protocol was employed to measure the H₂S in the vapor phase of all the bottles as used to make the Blank reading. The difference between the Blank H₂S concentration and H₂S concentration observed with different concentrations of the scavenging products and formulations are noted as % scavenging. A higher % Scavenging with lower concentration of the scavenging product is considered as better H₂S scavenger for the set of experiment.

The protocol of measurement was repeated three times with each scavenging composition and the indicated percentage was calculated based on the average of the measurements.

### EXAMPLE 3: Measurement of H₂S Scavenging Ability of the Scavenging Compositions Under Modified ASTM D-5705 Conditions, as Detailed in Example 2

Table 2 below shows the percentage of H₂S reduction based on the measured H₂S amount in vapour phase after treatment with scavenging compositions detailed in table 1 above.

TABLE 2

Scavenging efficiency (% of H₂S reduction) of the scavenging compositions and detailed in table 1

| | Sample 1 [1:0.1] | Sample 2 [1:0.2] | Sample 3 [1:0.3] | Sample 4 [1:0.4] | Sample 5 [1:0.5] | Sample 6 [1:0.6] | Sample 7 [1:0.7] | Sample 8 [1:0.8] | Sample 9 [1:0.9] | Sample 10 [1:1] |
|---|---|---|---|---|---|---|---|---|---|---|
| C1 | 30 | 42 | 54 | 65 | 72 | 77 | 80 | 85 | 92 | 100 |
| C2 | 0 | 0 | 0 | 0 | 0 | 0 | 0 | 0 | 0 | 0 |
| C3 | 0 | 0 | 0 | 0 | 0 | 0 | 0 | 0 | 0 | 0 |
| C4 | 0 | 0 | 0 | 0 | 0 | 0 | 0 | 0 | 0 | 0 |
| C5 | 50 | 65 | 80 | 92 | 98 | 100 | 100 | 100 | 100 | 100 |
| I1 | 40 | 60 | 72 | 88 | 93 | 98 | 100 | 100 | 100 | 100 |
| I2 | 32 | 53 | 68 | 76 | 88 | 95 | 100 | 100 | 100 | 100 |
| I3 | 38 | 58 | 86 | 90 | 96 | 100 | 100 | 100 | 100 | 100 |
| I4 | 84 | 98 | 100 | 100 | 100 | 100 | 100 | 100 | 100 | 100 |
| I5 | 90 | 98 | 100 | 100 | 100 | 100 | 100 | 100 | 100 | 100 |
| I6 | 80 | 96 | 100 | 100 | 100 | 100 | 100 | 100 | 100 | 100 |

The results in Table 2 clearly show that the scavenging compositions of the present invention are much more efficient than the scavenging compositions of the prior art C1. Indeed, we can see at for all the sample, the percentage of H2S reduction is always higher for the scavenging compositions of the invention.

If we refer for example to sample 2 wherein the weight ratio H₂S:scavenging composition is 1:0.2, we can observe that 58% of the H₂S have been scavenged with the scavenging composition I3 according to the invention and even 60% of the H₂S with the scavenging composition I1, whereas only 42% of the H₂S have been scavenged with the scavenging composition C1 of prior art.

The results in Table 2 also clearly show that the synergistic additive has no direct effect on the scavenging of hydrogen sulphide. This confirms that said additive cannot itself scavenge H₂S but has a boosting effect when used together with an H₂S scavenging compound.

If we compare the comparative composition C5 (scavenging composition containing 50%wt of MEA-triazine) with the compositions I4, I5 and I6 according to the invention (scavenging composition containing 50%wt of MEA-triazine and a synergistic additive as defined in the invention), it can be observed that the compositions according to the invention are much more efficient than the comparative composition C5.

If we refer for example to sample 2 wherein the weight ratio H₂S:scavenging composition is 1:0.2, we can observe that 96% of the H₂S have been scavenged with the scavenging composition I6 according to the invention and even 98% of the H₂S with the scavenging compositions I4 and I5, whereas 65% of the H₂S have been scavenged with the scavenging composition C5 of the prior art.

### EXAMPLE 4: Measurement of H₂S Scavenging Ability of the Scavenging Compositions

In this example, the kinetic of the H2S scavenging effect of the scavenging compositions of example 1 had been evaluated.

In a typical experiment, dry H₂S gas with 50 ppm of concentration being passed through the hydrocarbon media, with 0.3 L/min flow rate and 1.5 psi pressure. The H₂S scavenger being dosed into gas purging bottle, typically being charged with 100 mL of hydrocarbon media (0.4 mL of sample + 1.6 mL of butyl carbitol). The outlet of this gas purging botte is passed through the gas scrubber. The gas scrubber typically scrubs all the gases and vapor apart from H₂S and allows to pass only H₂S gas to the detector. The detector shows the actual concentration of H₂S in real time throughout the experiment. Finally, the outlet from the H₂S detector is passed through aq. NaOH solution in order to neutralize the H₂S gas.

The test had been performed in a dearomatized hydrocarbon solvent (HC1) having an initial boiling point higher than 120° C., a final boiling point higher than 250° C. and a flash point above 100° C. with aromatic content less than 0.05%wt has been used for the tests.

The following protocol had been implemented:

1. Transfer 100 mL of hydrocarbon solvent (HC1 detailed above) to gas-purging bottle. Fit the fritted glass bubbler at the opening of the bottle. Assemble the gas purging bottle/glass frit apparatus. Place the bottle into the oil bath.

2. Fit one end of the Tygon tube at the outlet of the H₂S gas cylinder, and its another end to a gas flowmeter. Connect the outlet of the gas flowmeter to inlet of the fritted glass bubbler using Tygon tube. Outlet of the condenser will be connected to gas scrubber, to ensure all the other gases get trapped and only H₂S goes to the detector.

3. Finally, outlet of the detector is attached to H₂S neutralizing unit which contains aq. NaOH solution.

4. Start the flow of H₂S gas with 50 ppm concentration in N₂. Ensure that the pressure maintain to 0.3 L/min all the times, with 1.5 psi pressure.

5. Purge the content of the gas purging bottle for at least 15-20 min, to remove all the dissolved oxygen, and till constant 50 ppm reading is shown at H₂S detector.

6. Once the constant 50 ppm concentration is displayed at H₂S detector, measured quantity of the H₂S scavenger to be injected using syringe through the H₂S scavenger dosing point into the hydrocarbon media present in the gas purging bottle.

7. H₂S detector is inbuild with data logger which save the readings after every 5 seconds delay.

8. Upon completion of the experiment, typically being run for 30 min. The H₂S detector is connected to computer to retrieve the data.

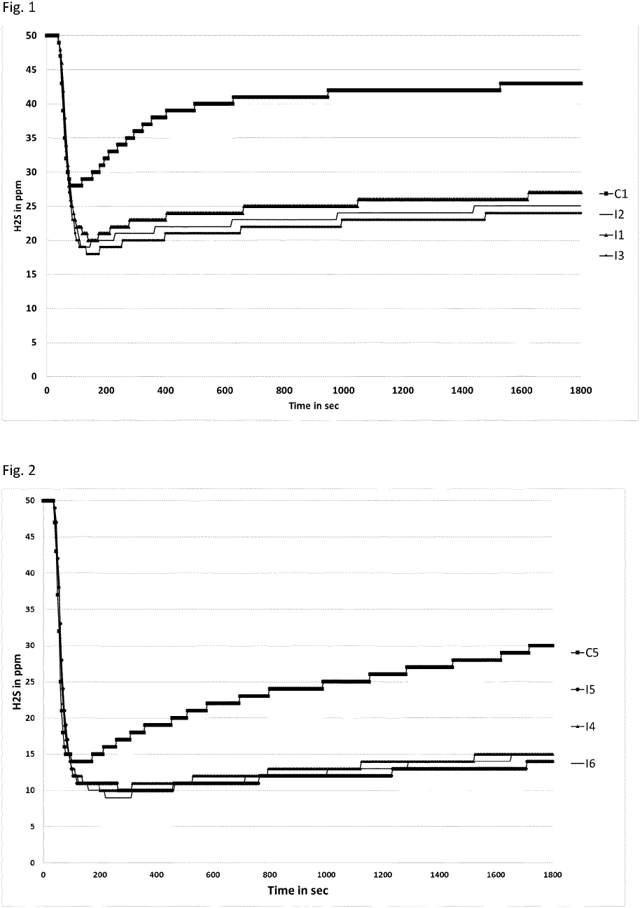

The H₂S amount in ppm in function of the time had been measured and is shown in FIG. 1 and FIG. 2.

The results illustrated in FIG. 1 and FIG. 2 show that the scavenging compositions of the invention comprising MBO (FIG. 1) or MEA-triazine (FIG. 2) in combination with a synergistic additive provide much improved scavenging performances than comparative compositions C1 and C5 comprising only MBO or MEA-triazine. It can additionally be noted that the H₂S scavenging effect is maintained over time, since the amount of H₂S is lower than 20 ppm (for scavenging compositions I4, I5 and I6) or even lower than 15 ppm after 1800 seconds for the scavenging composition I5 according to the invention, while H₂S is continuously added during the test. On the contrary, with the scavenging compositions C1 and C5, the amount of H₂S is first decreased (in a lower extent than with the scavenging compositions of the invention) and then is increased, while H₂S is continuously added during the test.

1. A composition for scavenging hydrogen sulphide and mercaptans in hydrocarbon streams, said composition comprising at least one H2S scavenger compound and at least one additive,
the H2S scavenger compound being selected from oxazolidine compounds, triazine, and metal-based carboxylate, and
the additive being a copolymer comprising m units of formula (II) and p units of formula (III), wherein: 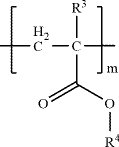 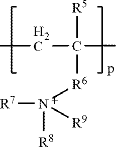
Wherein
R³ and R⁵ are, independently to each other, a hydrogen atom or a methyl group,
m is an integer ranging from 2 to 200,
p is an integer ranging from 2 to 100,
R⁴ represents independently to each other, a monovalent radical selected from linear, branched, cyclic, alkyl or alkenyl groups having from 1 to 36 carbon atoms and aryl groups having from 6 to 16 carbon atoms, said alkyl, alkenyl or aryl group may optionally be substituted by one or more heteroatoms, such as oxygen, sulfur, nitrogen atoms,
R⁶ represents independently to each other, a divalent radical selected from linear, branched, cyclic, alkylene or alkenylene groups having from 1 to 36 carbon atoms and arylene groups having from 6 to 16 carbon atoms, said alkylene, alkenylene or arylene group may optionally be substituted by one or more heteroatoms, such as oxygen, sulfur, nitrogen atoms,
R⁷, R⁸ and R⁹, are independently to each other, a monovalent radical selected from linear, branched, cyclic, alkyl or alkenyl groups having from 1 to 36 carbon atoms.

2. The composition according to claim 1, wherein the copolymer has a number average molecular weight ranging from 500 to 40000 g/mol .

3. The composition according to claim 1, wherein the polymer comprises from 1 to 100 units of formula (II) and from 2 to 50 units of formula (III) .

4. The composition according to claim 1, wherein in formula (II) and/or (III):
R⁴ represents, independently to each other, a monovalent radical selected from linear, branched, cyclic, alkyl or alkenyl groups having from 1 to 36 carbon atoms ; and/or
R⁶ represents, independently to each other, a divalent radical selected from linear, branched, cyclic, alkylene or alkenylene groups having from 1 to 36 carbon atoms ; and/or
R⁷, R⁸ and R⁹, are independently to each other, a monovalent radical selected from linear, branched, cyclic, alkyl or alkenyl groups having from 1 to 36 carbon atoms.

5. The composition according to claim 1, wherein in formula (II) and/or (III):
R³ and R⁵ represents independently to each other a hydrogen atom or a methyl group;
R⁴ represents, independently to each other, a monovalent radical selected from linear or branched alkyl groups having from 3 to 18 carbon atoms;
R⁶ represents a divalent group selected from —COO—R¹⁰—, OCOR¹⁰—, —Ph—CH₂—, wherein R¹⁰ is an alkylene group having from 1 to 12 carbon atoms and wherein Ph represents a phenyl group;
R⁷, R⁸ and R⁹, are independently to each other, a monovalent radical selected from linear or branched alkyl groups having from 1 to 12 carbon atoms.

6. The composition according to claim 1, wherein the copolymer is a bloc copolymer.

7. The composition according to claim 1, comprising:
from 10 to 80%wt, of H2S scavenger compound, based on the total weight of the composition, and
from 0.5 to 30%wt, of active matter of copolymer additive(s), based on the total weight of the composition.

8. The composition according to claim 1, wherein the weight ratio of H2S scavenger compound(s) to said additive(s) ranges from 1 to 50.

9. The composition according to claim 1, further comprising at least one solvent composition.

10. The composition according to claim 1, comprising:
From 20 to 90%wt of H2S scavenger compound(s),
From 0.1 to 30%wt of active matter of said copolymer additive(s), and
From 10 to 70%wt of solvent(s),
based on the total weight of the composition.

11. The composition according to claim 1, wherein the H2S scavenger compound is an oxazolidine compound .

12. A method for improving the efficiency of a H2S scavenger compound selected from oxazolidine compounds, triazine compounds, and metal-based carboxylate for scavenging hydrogen sulphide and/or mercaptans in hydrocarbon streams, the method comprising mixing the additive defined in claim 1 with the H2S scavenger compound selected from oxazolidine compounds, triazine compounds, and metal-based carboxylate.

13. Hydrocarbon stream comprising hydrocarbons and a composition according to claim 1.

14. Hydrocarbon streams according to claim 13, wherein the hydrocarbons are selected from crude oil, fuel oil, fuel, Light Petroleum Gas, natural gas, bitumen and petroleum residues.

15. A method for scavenging hydrogen sulphide and/or mercaptans in hydrocarbon streams, comprising contacting the hydrocarbon stream with the composition according to claim 1.

16. The composition according to claim 1, wherein the polymer comprises from 10 to 80 units of formula (II) and from 3 to 30 units of formula (III).

17. The composition according to claim 1, wherein the copolymer is a dibloc copolymer.

18. The composition according to claim 1, wherein the weight ratio of H2S scavenger compound(s) to said additive(s) ranges from 2 to 30.

19. The composition according to claim 1, further comprising at least one solvent in an amount ranging from 1 to 80%wt, based on the total weight of the composition.

20. The composition according to claim 1, wherein the H2S scavenger compound is a bisoxazolidine compound.
